(19) United States
(12) Patent Application Publication
(10) Pub. No.: US 2018/0167533 A1
(43) Pub. Date: Jun. 14, 2018

(54) COLOR MANAGEMENT SYSTEM AND COLOR MANAGEMENT METHOD

(71) Applicant: QISDA CORPORATION, Taoyuan City (TW)

(72) Inventors: Chin-Sheng Lin, Taoyuan City (TW); Chun-Hsiang Liao, Chiayi City (TW)

(21) Appl. No.: 15/790,061

(22) Filed: Oct. 23, 2017

(30) Foreign Application Priority Data
Dec. 14, 2016 (TW) 105141374

(51) Int. Cl. H04N 1/60; H04N 1/54

(52) U.S. Cl. CPC H04N 1/6002; H04N 1/54

(57) ABSTRACT

A color management system includes a host device and a display device. An operating system is installed in the host device and a first ICC profile is applied to the operating system. The display device communicates with the host device. The display device can be switched between a plurality of color modes. The display device stores a plurality of second ICC profiles, wherein each of the second ICC profiles corresponds to one of the color modes. When the display device is switched to an i-th color mode of the color modes, the host device determines whether the first ICC profile is identical to an i-th second ICC profile corresponding to the i-th color mode. When the host device determines that the first ICC profile is different from the i-th second ICC profile, the host device applies the i-th second ICC profile to the operating system.

### BACKGROUND OF THE INVENTION

### 1. Field of the Invention

The invention relates to a color management system and a color management method and, more particularly, to a color management system and a color management method capable of ensuring that an ICC profile of a color mode of a display device is identical to an ICC profile of an operating system of a host device.

### 2. Description of the Prior Art

An ICC profile is a set of data that characterizes a color input or output device or a color space according to standards promulgated by the International Color Consortium (ICC) . The ICC profile is widely used in color management to maintain color consistency between a device and a file, so as to provide an optimal color performance on a target device or simulate the color performance of the file in associated with the target device on other devices. In the prior art, the color management needs to use a color calibrator and specific software to make the ICC profile and then applies the ICC profile to the operating system. The aforesaid operation has to be implemented by one skilled in the art . In other words, a common user cannot perform the aforesaid complicated color management setting by himself/herself.

### SUMMARY OF THE INVENTION

An objective of the invention is to provide a color management system and a color management method capable of ensuring that an ICC profile of a color mode of a display device is identical to an ICC profile of an operating system of a host device, so as to solve the aforesaid problems.

According to an embodiment of the invention, a color management system comprises a host device and a display device. An operating system is installed in the host device and a first ICC profile is applied to the operating system. The display device communicates with the host device. The display device is capable of being switched between a plurality of color modes. The display device stores a plurality of second ICC profiles, wherein each of the second ICC profiles corresponds to one of the color modes. When the display device is switched to an i-th color mode of the color modes, the host device determines whether the first ICC profile is identical to an i-th second ICC profile corresponding to the i-th color mode, wherein i is a positive integer. When the host device determines that the first ICC profile is different from the i-th second ICC profile, the host device applies the i-th second ICC profile to the operating system.

According to another embodiment of the invention, a color management method is adapted to a host device and a display device communicating with the host device. An operating system is installed in the host device and a first ICC profile is applied to the operating system. The display device is capable of being switched between a plurality of color modes. The display device stores a plurality of second ICC profiles, wherein each of the second ICC profiles corresponds to one of the color modes. The color management method comprises steps of when the display device is switched to an i-th color mode of the color modes, the host device determining whether the first ICC profile is identical to an i-th second ICC profile corresponding to the i-th color mode, wherein i is a positive integer; and when the host device determines that the first ICC profile is different from the i-th second ICC profile, the host device applying the i-th second ICC profile to the operating system.

According to another embodiment of the invention, a color management system comprises a host device and a display device. An operating system is installed in the host device and a first ICC profile is applied to the operating system. The display device communicates with the host device. The display device is capable of being switched between a plurality of color modes . The display device stores a plurality of sets of color characteristic values, wherein each of the sets of color characteristic values corresponds to one of the color modes. When the display device is switched to an i-th color mode of the color modes, the host device determines whether the first ICC profile is identical to a second ICC profile corresponding to the i-th color mode, wherein i is a positive integer. When the host device determines that the first ICC profile is different from the second ICC profile, the host device converts an i-th set of color characteristic values corresponding to the i-th color mode into the second ICC profile and applies the second ICC profile to the operating system.

According to another embodiment of the invention, a color management method is adapted to a host device and a display device communicating with the host device. An operating system is installed in the host device and a first ICC profile is applied to the operating system. The display device is capable of being switched between a plurality of color modes. The display device stores a plurality of sets of color characteristic values, wherein each of the sets of color characteristic values corresponds to one of the color modes. The color management method comprises steps of when the display device is switched to an i-th color mode of the color modes, the host device determining whether the first ICC profile is identical to a second ICC profile corresponding to the i-th color mode, wherein i is a positive integer; and when the host device determines that the first ICC profile is different from the second ICC profile, the host device converting an i-th set of color characteristic values corresponding to the i-th color mode into the second ICC profile and applying the second ICC profile to the operating system.

As mentioned in the above, when the host device determines that the ICC profile of the operating system is different from the ICC profile of the color mode of the display device, the host device will apply the ICC profile of the color mode of the display device to the operating system automatically. The invention may store a plurality of ICC profiles or a plurality of sets of color characteristic values corresponding to a plurality of color modes in the display device in advance according to practical applications. Accordingly, when a user switches the color mode of the display device, the host device will perform color management setting automatically.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a color management system according to an embodiment of the invention.

FIG. 2 is a flowchart illustrating a color management method according to an embodiment of the invention.

FIG. 3 is a functional block diagram illustrating a color management system according to another embodiment of the invention.

FIG. 4 is a flowchart illustrating a color management method according to another embodiment of the invention.

### DETAILED DESCRIPTION

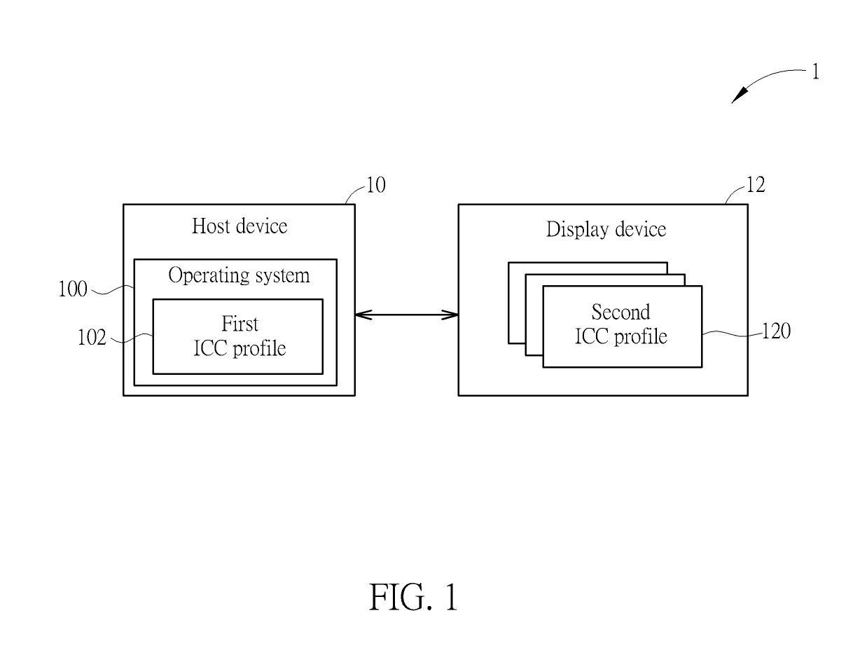

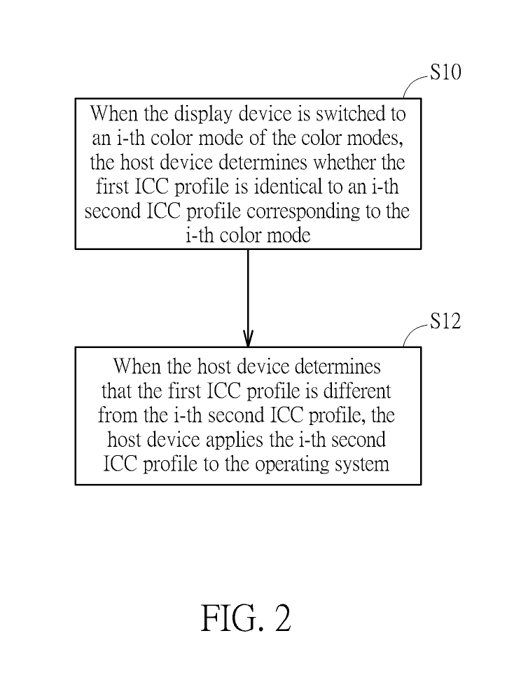

Referring to FIGS. 1 and 2, FIG. 1 is a functional block diagram illustrating a color management system 1 according to an embodiment of the invention and FIG. 2 is a flowchart illustrating a color management method according to an embodiment of the invention. The color management method shown in FIG. 2 can be implemented by the color management system 1 shown in FIG. 1.

As shown in FIG. 1, the color management system 1 comprises a host device 10 and a display device 12, wherein the display device 12 communicates with the host device 10. In practical applications, the display device 12 may communicate with the host device 10 by wired or wireless manner. In this embodiment, the host device 10 may be a computer, a server or other electronic devices, and the display device 12 may be a liquid crystal display (LCD) device, a plasma display device, an organic light emitting diode (OLED) display device or other display devices.

An operating system 100 is installed in the host device 10 and a first ICC profile 102 is applied to the operating system 100. The display device 12 is capable of being switched between a plurality of color modes. Furthermore, the display device 12 stores a plurality of second ICC profiles 120, wherein each of the second ICC profiles 120 corresponds to one of the color modes. In this embodiment, each of the aforesaid color modes may represent, but not limited to, a combination of color space, Gamma and color temperature. The color mode corresponding to each of the second ICC profiles 120 is unique and the most matched. A user may switch the color mode of the display device 12 by an on-screen display (OSD) of the display device 12 directly. Needless to say, the user may also input a command to the display device 12 by a software installed in the host device 10, so as to switch the color mode of the display device 12.

The color management method of the invention is adapted to the host device 10 and the display device 12 communicating with the host device 10. When the display device 12 is switched to an i-th color mode of the color modes, the host device 10 determines whether the first ICC profile 102 of the operating system 100 is identical to an i-th second ICC profile 120 corresponding to the i-th color mode (step S10 in FIG. 2), wherein i is a positive integer. When the host device 10 determines that the first ICC profile 102 of the operating system 100 is different from the i-th second ICC profile 120 corresponding to the i-th color mode, the host device 10 applies the i-th second ICC profile 120 corresponding to the i-th color mode to the operating system 100 (step S12 in FIG. 2). Accordingly, when the user switches the color mode of the display device 12, the host device 10 will perform color management setting automatically.

In this embodiment, when the host device 10 determines that the first ICC profile 102 of the operating system 100 is different from the i-th second ICC profile 120 corresponding to the i-th color mode, the host device 10 may further determine whether the i-th second ICC profile 120 corresponding to the i-th color mode is stored in the host device 10. When the host device 10 determines that the i-th second ICC profile 120 corresponding to the i-th color mode is stored in the host device 10, the host device 10 applies the i-th second ICC profile 120 corresponding to the i-th color mode to the operating system 100. On the other hand, when the host device 10 determines that the i-th second ICC profile 120 corresponding to the i-th color mode is not stored in the host device 10, the host device 10 downloads the i-th second ICC profile 120 corresponding to the i-th color mode from the display device 12 and applies the i-th second ICC profile 120 corresponding to the i-th color mode to the operating system 100.

In another embodiment, when the host device 10 determines that the first ICC profile 102 of the operating system 100 is different from the i-th second ICC profile 120 corresponding to the i-th color mode, the host device 10 may download the i-th second ICC profile 120 corresponding to the i-th color mode from the display device 12 and applies the i-th second ICC profile 120 corresponding to the i-th color mode to the operating system 100.

In another embodiment, when the host device 10 communicates with the display device 12 initially, the host device 10 may download the second ICC profiles 120 corresponding to the color modes from the display device 12. Accordingly, when the host device 10 determines that the first ICC profile 102 of the operating system 100 is different from the i-th second ICC profile 120 corresponding to the i-th color mode, the host device 10 can apply the i-th second ICC profile 120 corresponding to the i-th color mode to the operating system 100.

It should be noted that when the host device 10 determines that the first ICC profile 102 of the operating system 100 is identical to the i-th second ICC profile 120 corresponding to the i-th color mode, it represents that the color management has been optimal. Accordingly, the host device 10 needs not to perform any process.

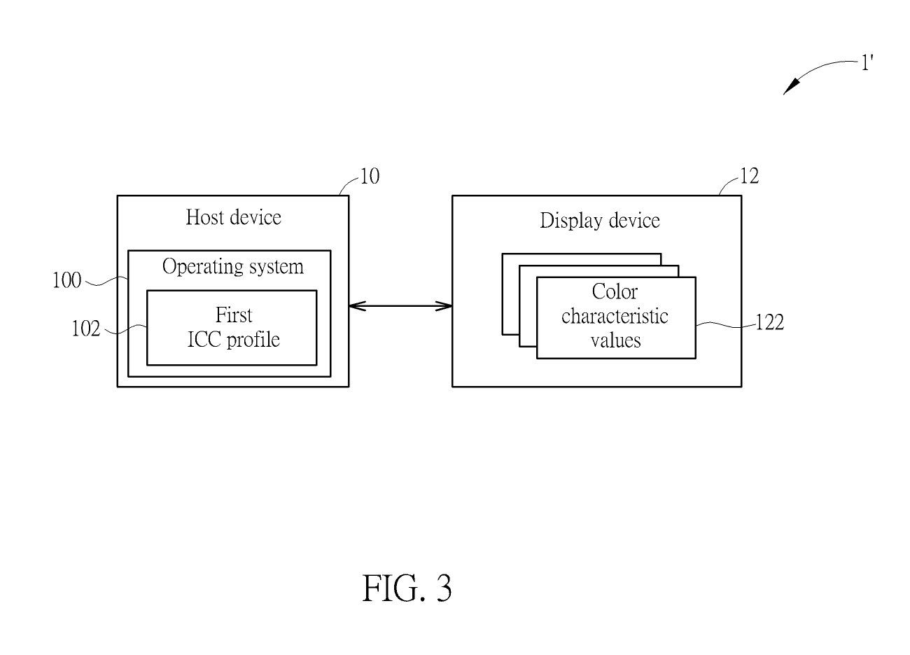

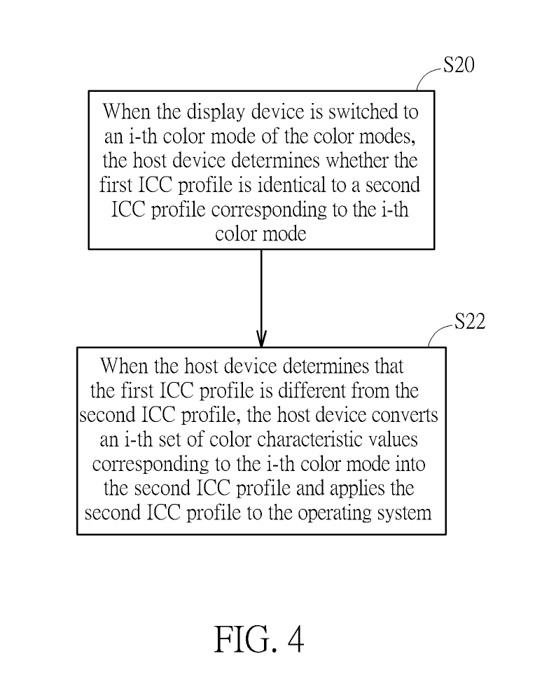

Referring to FIGS. 3 and 4, FIG. 3 is a functional block diagram illustrating a color management system 1′ according to another embodiment of the invention and FIG. 4 is a flowchart illustrating a color management method according to another embodiment of the invention. The color management method shown in FIG. 4 can be implemented by the color management system 1′ shown in FIG. 3.

The main difference between the color management system 1′ and the aforesaid color management system 1 is that the display device 12 of the color management system 1′ stores a plurality of sets of color characteristic values 122, wherein each of the sets of color characteristic values 122 corresponding to one of the color modes. Accordingly, when the display device 12 is switched to an i-th color mode of the color modes, the host device 10 determines whether the first ICC profile 102 of the operating system 100 is identical to a second ICC profile corresponding to the i-th color mode (step S20 in FIG. 4), wherein i is a positive integer. When the host device 10 determines that the first ICC profile 102 of the operating system 100 is different from the second ICC profile corresponding to the i-th color mode, the host device 10 converts an i-th set of color characteristic values corresponding to the i-th color mode into the second ICC profile corresponding to the i-th color mode and applies the second ICC profile corresponding to the i-th color mode to the operating system 100 (step S22 in FIG. 4). Accordingly, when the user switches the color mode of the display device 12, the host device 10 will perform color management setting automatically. It should be noted that the method of converting the color characteristic values into the ICC profile may be referred to Taiwan Patent No. 1340939 and it will not be depicted herein.

In this embodiment, when the host device 10 determines that the first ICC profile 102 of the operating system 100 is different from the second ICC profile corresponding to the i-th color mode, the host device 10 may further determine whether the second ICC profile corresponding to the i-th color mode is stored in the host device 10. When the host device 10 determines that the second ICC profile corresponding to the i-th color mode is stored in the host device 10, the host device 10 applies the second ICC profile corresponding to the i-th color mode to the operating system 100. On the other hand, when the host device 10 determines that the second ICC profile corresponding to the i-th color mode is not stored in the host device 10, the host device 10 downloads the i-th set of color characteristic values corresponding to the i-th color mode from the display device 12, converts the i-th set of color characteristic values corresponding to the i-th color mode into the second ICC profile corresponding to the i-th color mode, and applies the second ICC profile corresponding to the i-th color mode to the operating system 100.

In another embodiment, when the host device 10 determines that the first ICC profile 102 of the operating system 100 is different from the second ICC profile corresponding to the i-th color mode, the host device 10 may download the i-th set of color characteristic values corresponding to the i-th color mode from the display device 12, converts the i-th set of color characteristic values corresponding to the i-th color mode into the second ICC profile corresponding to the i-th color mode, and applies the second ICC profile corresponding to the i-th color mode to the operating system 100.

In another embodiment, when the host device 10 communicates with the display device 12 initially, the host device 10 may download the sets of color characteristic values from the display device 12. Accordingly, when the host device 10 determines that the first ICC profile 102 of the operating system 100 is different from the i-th second ICC profile 120 corresponding to the i-th color mode, the host device 10 can convert the i-th set of color characteristic values corresponding to the i-th color mode into the second ICC profile corresponding to the i-th color mode and apply the second ICC profile corresponding to the i-th color mode to the operating system 100.

It should be noted that when the host device 10 determines that the first ICC profile 102 of the operating system 100 is identical to the second ICC profile corresponding to the i-th color mode, it represents that the color management has been optimal. Accordingly, the host device 10 needs not to perform any process.

It should be noted that the control logic of the color management method of the invention can be implemented by software. Furthermore, each part or function of the control logic of the color management method of the invention may be implemented by software, hardware or the combination thereof.

As mentioned in the above, when the host device determines that the ICC profile of the operating system is different from the ICC profile of the color mode of the display device, the host device will apply the ICC profile of the color mode of the display device to the operating system automatically. The invention may store a plurality of ICC profiles or a plurality of sets of color characteristic values corresponding to a plurality of color modes in the display device in advance according to practical applications. Accordingly, when a user switches the color mode of the display device, the host device will perform color management setting automatically.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A color management system comprising:
a host device, an operating system being installed in the host device, a first ICC profile being applied to the operating system; and
a display device communicating with the host device, the display device being capable of being switched between a plurality of color modes, the display device storing a plurality of second ICC profiles, each of the second ICC profiles corresponding to one of the color modes;
wherein when the display device is switched to an i-th color mode of the color modes, the host device determines whether the first ICC profile is identical to an i-th second ICC profile corresponding to the i-th color mode, i is a positive integer; when the host device determines that the first ICC profile is different from the i-th second ICC profile, the host device applies the i-th second ICC profile to the operating system.

2. The color management system of claim 1, wherein when the host device determines that the first ICC profile is different from the i-th second ICC profile, the host device determines whether the i-th second ICC profile is stored in the host device; when the host device determines that the i-th second ICC profile is stored in the host device, the host device applies the i-th second ICC profile to the operating system.

3. The color management system of claim 2, wherein when the host device determines that the i-th second ICC profile is not stored in the host device, the host device downloads the i-th second ICC profile from the display device and applies the i-th second ICC profile to the operating system.

4. The color management system of claim 1, wherein when the host device determines that the first ICC profile is different from the i-th second ICC profile, the host device downloads the i-th second ICC profile from the display device and applies the i-th second ICC profile to the operating system.

5. The color management system of claim 1, wherein when the host device communicates with the display device initially, the host device downloads the second ICC profiles from the display device.

6. A color management method adapted to a host device and a display device communicating with the host device, an operating system being installed in the host device, a first ICC profile being applied to the operating system, the display device being capable of being switched between a plurality of color modes, the display device storing a plurality of second ICC profiles, each of the second ICC profiles corresponding to one of the color modes, the color management method comprising steps of:
when the display device is switched to an i-th color mode of the color modes, the host device determining whether the first ICC profile is identical to an i-th second ICC profile corresponding to the i-th color mode, wherein i is a positive integer; and
when the host device determines that the first ICC profile is different from the i-th second ICC profile, the host device applying the i-th second ICC profile to the operating system.

7. The color management method of claim 6, further comprising steps of:
when the host device determines that the first ICC profile is different from the i-th second ICC profile, the host device determining whether the i-th second ICC profile is stored in the host device; and
when the host device determines that the i-th second ICC profile is stored in the host device, the host device applying the i-th second ICC profile to the operating system.

8. The color management method of claim 7, further comprising step of:
when the host device determines that the i-th second ICC profile is not stored in the host device, the host device downloading the i-th second ICC profile from the display device and applying the i-th second ICC profile to the operating system.

9. The color management method of claim 6, further comprising step of:
when the host device determines that the first ICC profile is different from the i-th second ICC profile, the host device downloading the i-th second ICC profile from the display device and applying the i-th second ICC profile to the operating system.

10. The color management method of claim 6, further comprising step of:
when the host device communicates with the display device initially, the host device downloading the second ICC profiles from the display device.

11. A color management system comprising:
a host device, an operating system being installed in the host device, a first ICC profile being applied to the operating system; and
a display device communicating with the host device, the display device being capable of being switched between a plurality of color modes, the display device storing a plurality of sets of color characteristic values, each of the sets of color characteristic values corresponding to one of the color modes;
wherein when the display device is switched to an i-th color mode of the color modes, the host device determines whether the first ICC profile is identical to a second ICC profile corresponding to the i-th color mode, i is a positive integer; when the host device determines that the first ICC profile is different from the second ICC profile, the host device converts an i-th set of color characteristic values corresponding to the i-th color mode into the second ICC profile and applies the second ICC profile to the operating system.

12. The color management system of claim 11, wherein when the host device determines that the first ICC profile is different from the second ICC profile, the host device determines whether the second ICC profile is stored in the host device; when the host device determines that the second ICC profile is stored in the host device, the host device applies the second ICC profile to the operating system.

13. The color management system of claim 12, wherein when the host device determines that the second ICC profile is not stored in the host device, the host device downloads the i-th set of color characteristic values from the display device, converts the i-th set of color characteristic values into the second ICC profile, and applies the second ICC profile to the operating system.

14. The color management system of claim 11, wherein when the host device determines that the first ICC profile is different from the second ICC profile, the host device downloads the i-th set of color characteristic values from the display device, converts the i-th set of color characteristic values into the second ICC profile, and applies the second ICC profile to the operating system.

15. The color management system of claim 11, wherein when the host device communicates with the display device initially, the host device downloads the sets of color characteristic values from the display device.

16. A color management method adapted to a host device and a display device communicating with the host device, an operating system being installed in the host device, a first ICC profile being applied to the operating system, the display device being capable of being switched between a plurality of color modes, the display device storing a plurality of sets of color characteristic values, each of the sets of color characteristic values corresponding to one of the color modes, the color management method comprising steps of:
when the display device is switched to an i-th color mode of the color modes, the host device determining whether the first ICC profile is identical to a second ICC profile corresponding to the i-th color mode, wherein i is a positive integer; and
when the host device determines that the first ICC profile is different from the second ICC profile, the host device converting an i-th set of color characteristic values corresponding to the i-th color mode into the second ICC profile and applying the second ICC profile to the operating system.

17. The color management method of claim 16, further comprising steps of:
when the host device determines that the first ICC profile is different from the second ICC profile, the host device determining whether the second ICC profile is stored in the host device; and
when the host device determines that the second ICC profile is stored in the host device, the host device applying the second ICC profile to the operating system.

18. The color management method of claim 17, further comprising step of:
when the host device determines that the second ICC profile is not stored in the host device, the host device downloading the i-th set of color characteristic values from the display device, converting the i-th set of color characteristic values into the second ICC profile, and applying the second ICC profile to the operating system.

19. The color management method of claim 16, further comprising step of:
when the host device determines that the first ICC profile is different from the second ICC profile, the host device downloading the i-th set of color characteristic values from the display device, converting the i-th set of color characteristic values into the second ICC profile, and applying the second ICC profile to the operating system.

20. The color management method of claim 16, further comprising step of:
when the host device communicates with the display device initially, the host device downloading the sets of color characteristic values from the display device.
